(19) United States
(12) Patent Application Publication
(10) Pub. No.: US 2026/0131436 A1
(43) Pub. Date: May 14, 2026

(54) WRENCH FOR REMOVING DAMAGED THREADED FASTENERS

(71) Applicant: JIA-YING LIN, TAICHUNG CITY (TW)

(72) Inventor: JIA-YING LIN, TAICHUNG CITY (TW)

(21) Appl. No.: 19/382,212

(22) Filed: Nov. 6, 2025

(30) Foreign Application Priority Data
Nov. 11, 2024 (TW) 113212278

(51) Int. Cl. B25B 23/10; B25B 13/06; B25B 27/18

(52) U.S. Cl. CPC B25B 23/108; B25B 13/065; B25B 27/18

(57) ABSTRACT

A wrench for removing damaged threaded fasteners includes a main body and a clamping portion. The main body has a socket hole centered on a rotational center. The socket hole is configured to receive a fastener. The clamping portion is disposed along the inner periphery of the socket hole about the rotational center. The clamping portion has six first recess portions and six second recess portions alternately arranged and equally spaced in angular intervals. Each second recess portion is positioned between every two first recess portions. Each of the second recess portions is provided on its opposite sides with a first inclined force-applying surface and a second inclined force-applying surface, respectively. Each of the first and second inclined force-applying surfaces terminates in an abutting plane that faces the rotational center. When the abutting planes contact the fastener, slippage during turning operations is effectively prevented.

### BACKGROUND OF THE DISCLOSURE

### 1. Field of the Disclosure

This disclosure relates to wrenches, and more particularly to a wrench for removing damaged threaded fasteners.

### 2. Description of the Related Art

Screws, nuts, and other threaded fasteners constitute essential basic components of modern industry. In various assembly and disassembly operations, socket wrenches and star wrenches are extensively utilized for fastening and removing fasteners, as their socket structures enable accurate engagement with the fastener heads.

However, in practical applications, conventional socket wrenches and star wrenches are often subject to the following drawbacks:

Fastener damage issues: Under prolonged use or in harsh environments, fasteners tend to suffer from rustiness, wear, or corner fracture caused by excessive torque. When the socket hole of the wrench fails to properly engage a damaged screw, slippage may occur, thereby preventing smooth removal and possibly resulting in secondary damage to the fastener.

Limited tool applicability: Wrenches specifically designed for fasteners with certain damages generally have limited applicability, being suitable only for specific types of screw damage. When such tools are applied to intact fasteners, excessive force may instead induce additional damage.

### SUMMARY OF THE DISCLOSURE

To address the foregoing issues, this disclosure provides a wrench that is applicable to both damaged and undamaged fasteners. The wrench enables turning operations on damaged fasteners while preventing additional damage to the fasteners.

In one embodiment of this disclosure, a wrench for removing damaged threaded fasteners comprises a main body and a clamping portion. The main body is provided with a socket hole that is centered on a rotational center and configured to receive a fastener. The clamping portion is disposed along the inner periphery of the socket hole about the rotational center and comprising six first recess portions and six second recess portions alternately arranged and equally spaced in angular intervals, such that one said second recess portion is positioned between two adjacent said first recess portions, in which each of the second recess portions provided on opposite sides thereof with a first inclined force-applying surface and a second inclined force-applying surface, respectively, and the adjacent first and second inclined force-applying surfaces jointly define an included angle smaller than or equal to 120 degrees, wherein each of the first and second inclined force-applying surfaces terminates in a distinct abutting plane that faces the rotational center and each of the abutting planes has a width in a range of 0.1 mm to 0.5 mm.

Therein, where the fastener is a twelve-point threaded fastener, the first recess portion and the second recess portion correspondingly receive the apex corners of the threaded fastener and protect the apex corners from damage. Meanwhile, each apex corner is held by two adjacent abutting planes at bottom edges on both sides, so as to so firmly engage each apex corner at its root. This effective engagement prevents slippage and enables smooth turning operations.

Accordingly, the disclosed wrench is suitable for tightening or loosening operations of both damaged and undamaged threaded fastener, and its small operating angle helps save effort of users.

Additionally, in this disclosure, the included angle between the first inclined force-applying surface and the second inclined force-applying surface is smaller than or equal to 120 degrees. This minimizes wear caused by fasteners to the second recess portions, and in turn prolongs the service life of the wrench.

### BRIEF DESCRIPTION OF THE DRAWINGS

FIG. 1 is a top view of a wrench for removing damaged threaded fasteners according to one embodiment of this disclosure.

FIG. 2 is an applied view of the wrench for removing damaged threaded fasteners according to one embodiment of this disclosure, wherein the wrench receives a twelve-point fastener.

FIG. 3 is a partial, enlarged view of FIG. 2.

FIG. 4 is an applied view of the wrench for removing damaged threaded fasteners according to one embodiment of this disclosure, wherein the wrench receives a damaged twelve-point fastener.

FIG. 5 is an applied view of the wrench for removing damaged threaded fasteners according to one embodiment of this disclosure, wherein the wrench receives a Torx-type fastener.

FIG. 6 is an applied view of the wrench for removing damaged threaded fasteners according to one embodiment of this disclosure, wherein the wrench receives a damaged Torx-type fastener.

### DETAILED DESCRIPTION OF THE DISCLOSURE

For the purpose of illustrating the central concept disclosed in the foregoing summary of this disclosure, specific embodiments are presented below. It should be noted that the various elements shown in the embodiments are drawn in proportions suitable for explanatory purposes rather than in actual scale.

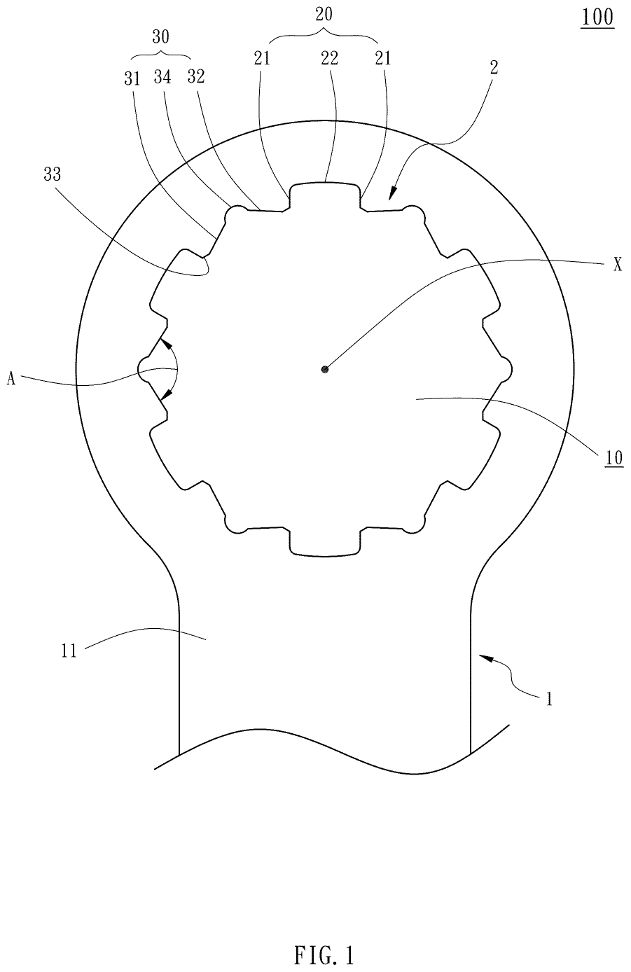

Referring to FIG. 1 through FIG. 6, this disclosure provides a wrench for removing damaged threaded fasteners 100, which comprises a main body 1 and a clamping portion 2.

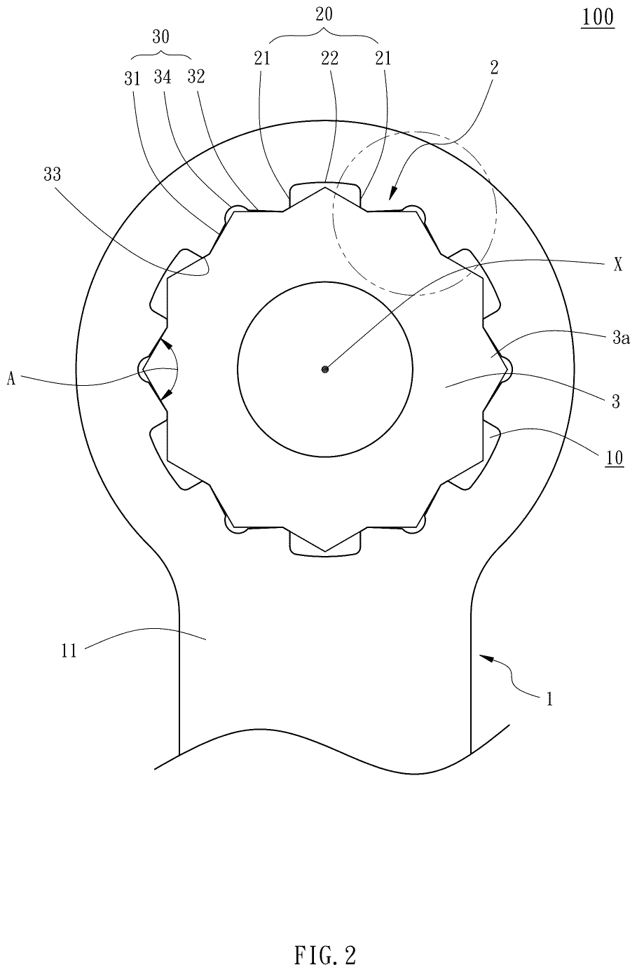

The main body 1 is provided with a socket hole 10 centered on a rotational center X. The socket hole 10 is configured to receive and engage a fastener 3, as shown in FIG. 2. In the present embodiment, the main body 1 further comprises a handle 11, and the socket hole 10 is formed at a working section extending away from the handle 11. The socket hole 10 is configured to receive and engage a fastener 3 from either the front or reverse side for turning operations. In the present embodiment, the main body 1 is a box-end wrench.

The clamping portion 2 is disposed along the inner periphery of the socket hole 10 about the rotational center X. The clamping portion 2 comprises six first recess portions 20 and six second recess portions 30 alternately arranged and equally spaced in angular intervals, such that one second recess portion 30 is positioned between every two first recess portions 20. The adjacent first recess portion 20 and second recess portion 30 define an angular spacing of 30 degrees. Each first recess portion 20 includes two side surfaces 21 and a bottom surface 22 connected between the two side surfaces 21.

Each second recess portion 30 is provided on its opposite sides with a first inclined force-applying surface 31 and a second inclined force-applying surface 32. Each of the first and second inclined force-applying surfaces 31, 32 terminates in a distinct abutting plane 33 that faces the rotational center X. In the present embodiment, each abutting plane 33 has a width in a range of 0.1 mm to 0.5 mm. The adjacent first inclined force-applying surface 31 and second inclined force-applying surface 32 jointly define an included angle A smaller than or equal to 120 degrees. In one embodiment, the included angle A between the first inclined force-applying surface 31 and the second inclined force-applying surface 32 is in a range of 116 degrees to 120 degrees.

Additionally, each adjacent first inclined force-applying surface 31 and the adjacent second inclined force-applying surface 32 are joined by an arc groove 34 disposed at a position relatively distant from the rotational center X.

In the present embodiment, the two side surfaces 21 are connected to the first inclined force-applying surface 31 and the second inclined force-applying surface 32, respectively. The two side surfaces 21 have lengths smaller than those of the first inclined force-applying surface 31 and the second inclined force-applying surface 32.

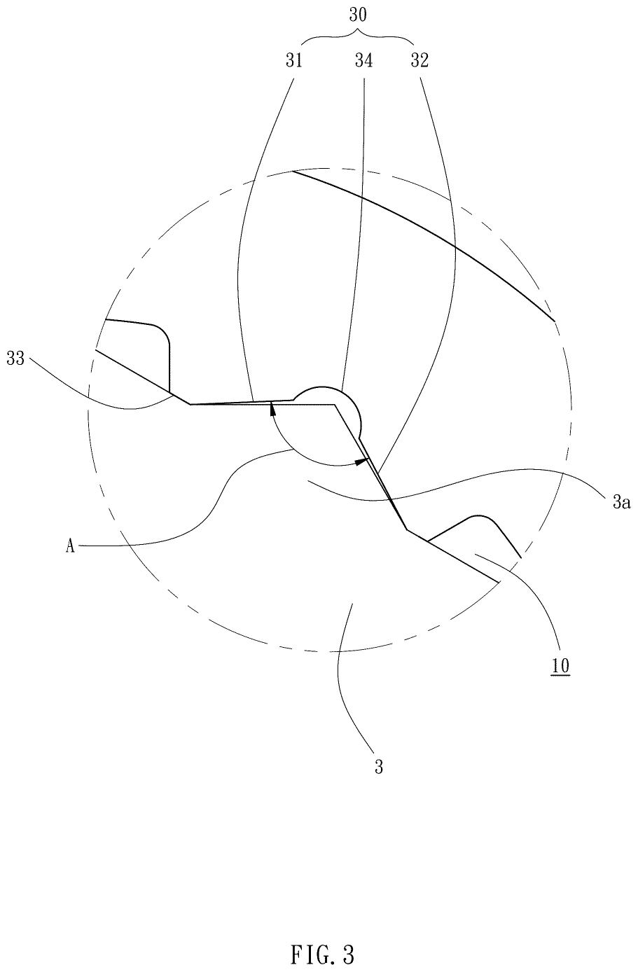

FIG. 2 and FIG. 3 schematically depict the wrench 100 of this disclosure engaging a fastener 3. As shown, the fastener 3 is a twelve-point threaded fastener, having twelve apex corners 3a. The six first recess portions 20 and the six second recess portions 30 of the clamping portion 2 correspondingly receive the twelve apex corners 3a, thereby achieving full circumferential engagement, which protects the apex corners 3a by preventing wear otherwise caused by loosen engagement. Furthermore, in this embodiment, the operating angle of the wrench is 30 degrees, allowing effortless operation. Since the included angle A between the first inclined force-applying surface 31 and the second inclined force-applying surface 32 is between 116 degrees and 120 degrees, the first inclined force-applying surface 31 and the second inclined force-applying surface 32 effectively contact the apex corners 3a during turning operations. As such, the wrench holds the fastener 3 firmly, and sliding friction therebetween can be reduced, thereby minimizing wear caused by the fastener 3 to both the first inclined force-applying surface 31 and second inclined force-applying surface 32. This in turn helps prevent wear of the second recess portion 30 (also undesired expansion of the included angle A), which prolongs the service life of the wrench.

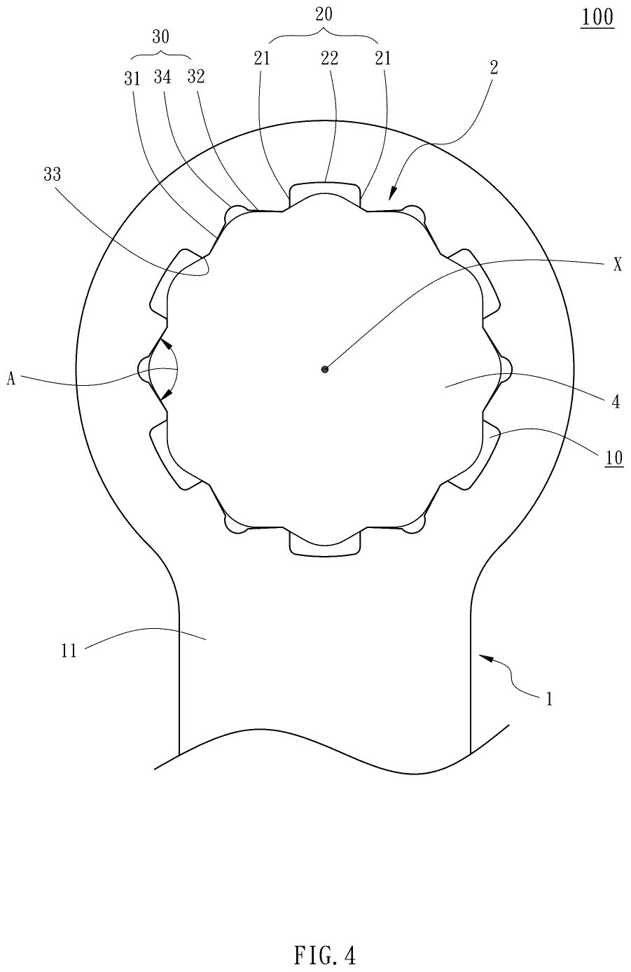

In this embodiment, during engagement, each abutting planes 33 is configured to closely contact the bottom edges on both sides of each apex corner 3a, so that the abutting planes 33 firmly engage the apex corner 3a at its root. This effective engagement prevents slippage and enables smooth turning operations. As shown in FIG. 4, where the fastener 4 is a twelve-point threaded fastener with a damaged apex corner, the disclosed wrench can still hold the fastener 4 tightly at the root of the apex corner 3a with its abutting planes 33, allowing a user to easily wrench and remove the damaged fastener 4.

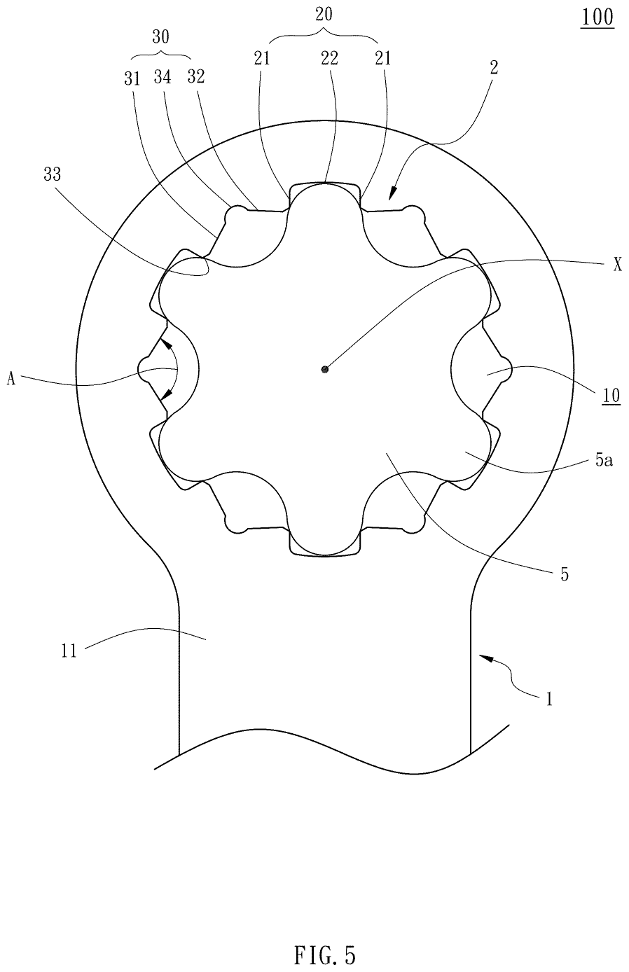

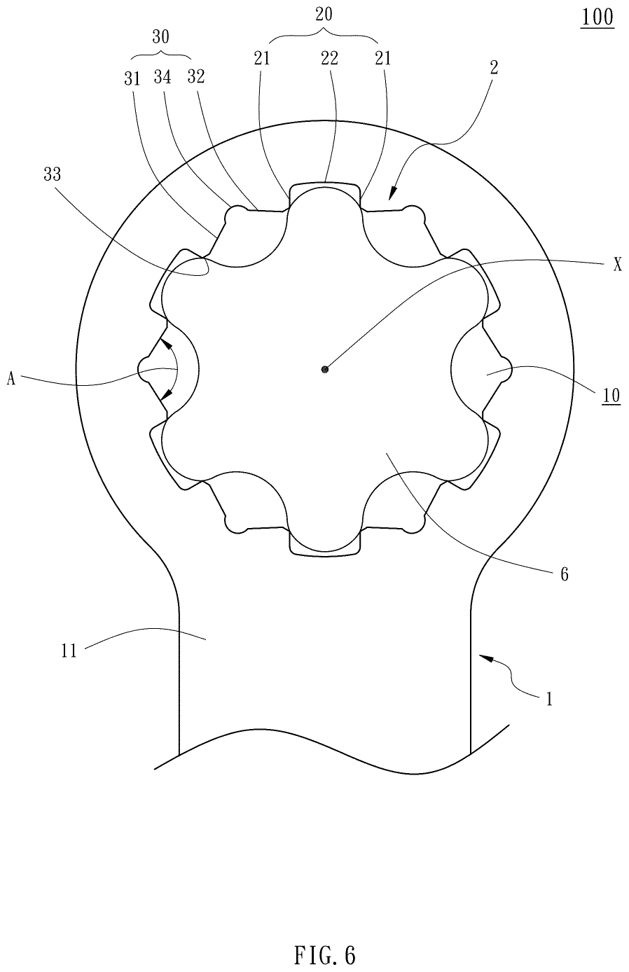

Referring to FIG. 5, the fastener 5 is a Torx screw, which has six rounded corners 5a. In this disclosure, the six first recess portions 20 are configured to accurately correspond to and engage the six rounded corners 5a, with the abutting planes 33 tightly contacting two sides of each rounded corner 5a, so as to enable stable turning operations. Similarly, as shown in FIG. 6, where the fastener 6 is a damage Torx-type threaded fastener, this disclosure is useful to wrench it.

This disclosure is also suitable for undamaged or damaged hexagonal threaded fasteners to enable smooth turning operations with the foregoing configuration.

To sum up, with the six first recess portions 20 and six second recess portions 30 of the clamping portion 2, the disclosed wrench is suitable for at least hexagonal threaded fasteners, twelve-point threaded fasteners, and Torx-type threaded fasteners. Even when the fastener is burred or deformed, the recess portions of the present disclosure can still effectively accommodate the burred or deformed areas, thereby facilitating smooth tightening or loosening operations.

With the foregoing structural design, this disclosure enables bidirectional tightening and loosening operations with a small operating angle, thereby saving effort of users.

This disclosure has been described with reference to the preferred embodiments and it is understood that the embodiments are not intended to limit the scope of this disclosure. Moreover, as the contents disclosed herein should be readily understood and can be implemented by a person skilled in the art, all equivalent changes or modifications which do not depart from the concept of this disclosure should be encompassed by the appended claims.

What is claimed is:

1. A wrench for removing a damaged threaded fastener, the wrench comprising:
a main body, provided with a socket hole that is centered on a rotational center and configured to receive a fastener; and
a clamping portion, disposed along an inner periphery of the socket hole about the rotational center and comprising six first recess portions and six second recess portions alternately arranged and equally spaced in angular intervals, such that one said second recess portion is positioned between two adjacent said first recess portions, in which each of the second recess portions is provided on opposite sides thereof with a first inclined force-applying surface and a second inclined force-applying surface, respectively, and the adjacent first and second inclined force-applying surfaces jointly define an included angle smaller than or equal to 120 degrees, wherein each of the first and second inclined force-applying surfaces terminates in a distinct abutting plane that faces the rotational center and each of the abutting planes has a width in a range of 0.1mm to 0.5mm.

2. The wrench for removing damaged threaded fasteners of claim 1, wherein the included angle between the adjacent first and second inclined force-applying surfaces is in a range of 116 degrees to 120 degrees.

3. The wrench for removing damaged threaded fasteners of claim 1, wherein the adjacent first and second inclined force-applying surfaces are joined by an arc groove disposed at a position relatively distant from the rotational center.

4. The wrench for removing damaged threaded fasteners of claim 3, wherein each of the first recess portions includes two side surfaces and a bottom surface connected between the two side surfaces, and the two side surfaces are connected to the first inclined force-applying surface and the second inclined force-applying surface, respectively, in which the two side surfaces have lengths smaller than lengths of the first inclined force-applying surface and the second inclined force-applying surface.

5. The wrench for removing damaged threaded fasteners of claim 1, wherein the fastener has twelve apex corners, and the six first recess portions and the six second recess portions are configured to correspondingly receive the twelve apex corners, so that each said apex corner is held by two adjacent said abutting planes at bottom edges on both sides.

6. The wrench for removing damaged threaded fasteners of claim 1, wherein the fastener has six rounded corners, and the first recess portions are configured to correspondingly receive the rounded corners, so that the abutting planes tightly contact two sides of each said rounded corner.
